(19) United States
(12) Patent Application Publication
(10) Pub. No.: US 2018/0073280 A1
(43) Pub. Date: Mar. 15, 2018

(54) MOTOR VEHICLE DOOR CLOSURE

(71) Applicant: Kiekert AG, Heiligenhaus (DE)

(72) Inventor: Carsten Fuchs, Essen (DE)

(21) Appl. No.: 15/565,210

(22) PCT Filed: Apr. 6, 2016
(86) PCT No.: PCT/DE2016/100160

§ 371 Date: Oct. 9, 2017

(30) Foreign Application Priority Data
Apr. 8, 2015 (DE) 10 2015 004 283.1

(51) Int. Cl. E05B 77/36; E05B 85/02; E05B 85/26

(52) U.S. Cl. CPC E05B 77/36; E05B 85/26; E05B 85/02

(57) ABSTRACT

The subject of the invention is a motor vehicle door closure which is equipped with a motor vehicle door lock (1) and, interacting therewith, a lock holder with a locking bolt (2). Also provided is a locking mechanism (3, 4) which is arranged in the motor vehicle door lock (1) and consists substantially of a rotary latch (3) and a pawl (4). There is additionally an actuating lever unit (7, 8, 9) which acts on the locking mechanism (3, 4). The rotary latch (3) is mounted in and/or on a lock case (5, 6) so as to be rotatable about an axis (10). At the end of its running-in movement into the locking mechanism (3, 4) and in its locking position in the running-in direction (E), the locking bolt (2) is arranged at a (distance I) in front of the axis (10) of the rotary latch (3). According to the invention, the actuating lever unit (7, 8, 9) is mounted at least for the most part on the lock case (5, 6).

The invention relates to a motor vehicle door latch, with a motor vehicle door latch and an interacting latch holder with a locking bolt, furthermore with a locking mechanism arranged in the motor vehicle door latch comprising a catch and a pawl, and with an activation lever mechanism working on the locking mechanism, whereby the catch is pivotably accommodated on an axis in and/or on a latch case, and whereby the locking bolt is arranged on the end of its inlet movement into the locking mechanism and in its closure position (the closure position of the locking mechanism) in an inlet direction at a distance in front of the axis of the catch.

In their fundamental construction, motor vehicle door latches comprise both the motor vehicle door latch and the interacting latch holder with a locking bolt. The latch holder is usually U-shaped, whereby the locking bolt defines the U-basis. The locking bolt can thus interact with the locking mechanism arranged in the motor vehicle door latch. The locking mechanism fundamentally comprises the catch and the pawl.

While the motor vehicle door latch is usually arranged on or in a motor vehicle door, the latch holder interacting with the motor vehicle door latch is usually on the chassis side with the locking bolt. For this purpose, the latch holder may, for example, be connected to a B- or C-pillar of a motor vehicle chassis. In principle, the procedure can also take place vice versa. In this case, the latch holder is connected to the motor vehicle door; in contrast the motor vehicle door latch is located in or on the motor vehicle chassis. Such embodiments are often executed as tailgate latches.

To close the motor vehicle door and consequently the motor vehicle door latch, the locking bolt enters the locking mechanism. The inlet movement of the locking bolt into the locking mechanism corresponds to this. At the end of this inlet movement into the locking mechanism and in the closed position of the locking mechanism the locking bolt is arranged in the inlet direction at a distance in front of the catch axis. The inlet direction of the locking bolt is defined and specified by its movement with the relevant closure process and the connected inlet movement of the locking bolt into the locking mechanism.

The class-specific state of the art according to WO 2014/082620 A2 describes such a motor vehicle door latch. At least one area of the axis of the catch is arranged adjacent to and/or in front of an internal end of the infeed section of the catch. Due to the distanced placement of the locking bolt in front of the catch axis in the closure position of the locking mechanism and at the end of the inlet movement of the locking bolt into the locking mechanism, special advantages are attained compared to the previous state of the art. In fact, with such motor vehicle door latches an especially large blocking part ratio is observed.

The blocking part ratio is a torque ratio or length ratio of two lever arms with constant force on the motor vehicle door latch which is usually exerted by a rubber door seal. The first lever arm or first lever is set between the catch axis and a main ratchet (or a pre-ratchet). The main ratchet usually corresponds to a main ratchet recess on the catch into which the pawl engages in the locking mechanism situated in the main ratchet position.

This first lever arm or first lever must be compared with a second lever arm or second lever. This second lever is observed between the locking bolt and the catch axis. Both lever arms describe distances of both the main ratchet recess from the catch axis (first lever) and of the locking bolt in the closure position of the locking mechanism of the stated axis (second lever).

As both lever arms or levers are aligned vertically to the force engaging through the rubber door seal on the locking bolt, they correspond to relevant torques which engage on the catch axis. In fact, the original torque engages on the catch axis and acts with the second lever or second lever arm in such a way that the catch is acted on in its opening direction. A force acting in an opening direction of the locking mechanism and resulting from the one or several rubber door seals on the motor vehicle door and consequently engaging on the motor vehicle door latch ensures this.

The pawl engaging into the main ratchet recess of the catch must generate a counter torque in order to be able to hold the catch in the main ratchet position in the example case. The first lever or first lever arm is present as a distance between the relevant main ratchet recess and the catch axis. The greater the length ratio of the first lever or lever arm compared to the length of the second lever or lever arm, the lesser forces the pawl needs to exert in the main ratchet position of the locking mechanism in order to hold the catch against the opening force acting in the opening direction of the rubber door seal in its closure position.

Thus, in the class-specific state of the art according to WO 2014/082620 A2 an attempt has been made to set the blocking part ratio to be as large as possible. This fundamentally succeeds due to the locking bolt being arranged at the end of this inlet movement into the locking mechanism and in the closure position of the locking mechanism at a distance before the catch axis. Because as a result in particular the length of the second lever or lever arm, i.e. the distance of the locking bolt can be specified and set especially slightly from the catch axis. However, limits are set on a relevant configuration to the extent that the locking bolt cannot be placed any distance in front of the catch axis. Because that ultimately leads to the motor vehicle door latch needing to be more and more of an unloading construction which is contrary to the usual efforts to execute a compact construction.

Furthermore, a large blocking part ratio generally implies that at least in the closure position of the locking mechanism the weight of the motor vehicle door additionally needs to be absorbed via a holding element. The holding element fixes the motor vehicle door latch compared to the latch holder, at least in the relevant closure position of the locking mechanism. In principle, such a holding element is also dispensable, however.

It should be emphasized that the closure position of the locking mechanism—not necessarily—corresponds to the main ratchet position. Instead, the reflections and considerations outlined above can be transferred to a pre-ratchet position of the locking mechanism just as easily and are equally valid. i.e. the term “closure position of the locking mechanism” according to the invention means both the main ratchet position and also the pre-ratchet position of the locking mechanism.

In any case, the blocking part ratio of 2:1 or 3:1, for example, or even more connected to the arrangement of the locking bolt at the end of its inlet movement in front of the catch axis leads to the force acting on the pawl being considerably reduced in the relevant closure position compared to previous embodiments. The pawl can thus even be manufactured from less robust materials than previously, for example, from plastic without endangering the stability of the locking mechanism overall. Furthermore, this has a positive impact on the noise evolution as the so-called “opening plop” ceases to apply or is at least considerably reduced from a noise perspective compared to previous designs.

The configuration of the class-specific motor vehicle door latch according to WO 2014/082620 A2 has fundamentally been proven. However, in addition to the described advantages with regard to noise evolution and choice of materials of the pawl, further improvements are possible. This is where the invention starts from.

The invention is based on the technical problem of further developing such a motor vehicle door latch in such a way that an especially compact construction form is observed in a protected construction and further reduction of noise evolution is executed.

In order to solve this technical problem, a class-specific motor vehicle door latch within the scope of the invention is characterized by the activation lever mechanism being accommodated on the latch case, at least mainly.

According to an advantageous configuration, the cross-section of the latch case is L-shaped. An L-leg of the latch case which is L-shaped in the cross section functions as a locking mechanism leg. The locking mechanism leg accommodates the locking mechanism, consequently crucially the catch and the pawl. In contrast, the other L-leg of the latch case configured as an L-shape in the cross-section is configured as a lever mechanism leg. The lever mechanism leg largely accommodates the activation lever mechanism.

According to the invention, the arrangement of the locking bolt at the end of its inlet movement opens into the locking mechanism and into the closure movement of the locking mechanism in front of the catch axis, i.e. not only the possibility to be able to work with a large blocking part ratio where values can be more than 3:1 and in particular more than 4:1. But this configuration also enables the configuration according to the invention in such a way that namely the latch case or its lever mechanism leg is present and largely used to accommodate the activation lever mechanism. Hereby, the invention starts from the insight that by means of the arrangement of the locking bolt in the closure position of the locking mechanism in front of the catch axis the catch overall can be moved in the inlet direction of the locking bolt “backwards” in the latch case or on the locking mechanism leg compared to the state of the art. Because in the conventional motor vehicle door latches the closure position of the locking mechanism regularly corresponds to the locking bolt being arranged below or above the catch axis, but not “in front of” the relevant axis.

As already explained, the latch case in the cross-section is regularly L-shaped. The one L-leg or locking mechanism leg usually functions as a carrier plate horizontal in the top view to mount and accommodate the locking mechanism. In contrast, the other L-leg or lever mechanism leg is usually connected at a right angle to the locking mechanism leg, namely in the area of an inlet opening of the locking mechanism leg for the locking bolt. The configuration according to the invention is such that the locking bolt is arranged in the closure position of the locking mechanism in front of the catch axis, now compared to the state of the art leads to the catch axis having a larger distance to the lever mechanism leg according to the invention than observed or possible in the state of the art. Because in the state of the art the locking bolt is located in the closure position of the locking mechanism—as stated—above or below the catch axis; the locking bolt and the catch axis are practically located in a common plane.

As the catch executes rotational movements around its axis both when closing and opening the locking mechanism, there is not sufficient space between the prominent L-leg or lever mechanism leg and a front edge of the catch during its movement in the state of the art. The previous state of the art thus dispenses with a configuration of the prominent L-leg as a lever mechanism leg because the accommodation of the activation lever mechanism is not possible due to narrow space.

In contrast, the significant increase in the distance of the catch axis compared to the prominent L-leg of the latch case in the invention leads to this prominent L-leg being able to be formed as a lever mechanism leg and thus is largely available at least to accommodate the activation lever mechanism. Within the scope of the invention, this means that at least a triggering lever can be placed and accommodated as a component of the lever mechanism on the relevant L-leg or lever mechanism leg. Usually, in addition to the relevant triggering lever at least an internal activation lever and also an external activation lever are arranged and accommodated on the relevant protruding L-leg of the latch case or the lever mechanism leg.

As a start, the number of required components is thus reduced. Because accommodation of the activation lever mechanism usually occurs independently of the latch case in a latch lid or latch housing sealing the latch cases. Relevant bearing positions must be provided for to this end for the activation lever mechanism in the latch lid. This is not necessary according to the invention as only the prominent L-leg provided for stability reasons is additionally optimized as a lever mechanism leg and provides bearing points which are simple to execute for at least the triggering lever.

In addition to the reduction in the number of components, a further advantage is observed in that due to the prominent L-leg of the latch case configured as a lever mechanism leg according to the invention the leaktightness of the entire motor vehicle door latch is significantly increased according to the invention.

Because especially the viewed area of the inlet opening in the latch case is exposed to environmental influences and humidity. As now according to the invention the prominent L-leg acts as a lever mechanism leg here and consequently possesses a larger surface expansion than previously, any seams between the latch case and the housing lid are relocated out of the area which is particularly at risk of environmental impacts, usually inside the pertaining motor vehicle door. Overall, the protection from dust and water is hereby considerably increased compared to the state of the art.

This all succeeds with consideration of a compact construction because the locking mechanism leg only mounts and accommodates the locking mechanism fundamentally comprising a catch and a pawl; in contrast, the lever mechanism leg predominantly of the activation lever mechanism is used for accommodation. These are the fundamental advantages.

According to a further advantageous design, the pawl describes a closure angle in the inlet movement of the locking bolt into the locking mechanism which, according to the invention, is less than 30° and in particular less than 25°, in relation to a pawl axis. Preferably even closure angles of the pawl are observed which are usually established at less than 20°. The closure angle is that angle which (as a maximum) describes and highlights the pawl in the inlet movement of the locking bolt.

In fact, the catch is usually equipped with a pre-ratchet recess and a main ratchet recess. The pawl initially engages into the pre-ratchet recess. In the further closure movement, the catch is usually further pivoted around its axis in a clockwise direction starting from the pre-ratchet position attained in such a manner, through the inlet movement of the locking bolt into the locking mechanism. In the transition from the pre-ratchet position to the main ratchet position, a ramp formed on the catch between the pre-ratchet recess and the main ratchet recess ensures that the pawl is pivoted around its axis in this process. A pivoting angle of the pawl around its axis results from this.

If the pivoting angle highlighted by the pawl is viewed in this process, a maximum pivoting angle of the pawl is usually set at the end of the inlet movement which corresponds to the relevant closure angle. After highlighting the closure angle, the pawl can then engage into the main ratchet recess of the catch. This closure angle or maximum pivot angle is usually less than 30° according to the invention. Thus, in the described closure movement of the locking mechanism and consequently the inlet movement of the locking bolt into the locking mechanism the pawl experiences a rotational movement around its axis. This rotational movement around its axis or a rotational acceleration of the pawl which also corresponds to this in the described closure process assumes particularly small values according to the invention compared to the state of the art.

In fact, the speed of the pawl is measured as a highlighted pivoting angle per time unit. The acceleration can be interpreted as a temporal change to this speed. Compared to the state of the art, comparable times overall are observed for the entire closure movement of the locking mechanism. However, as during these closure times the pawl only completes extremely small closure angles of less than 30° and in particular even less than 25° according to the invention, both lower closure speeds and also lower closure accelerations of the pawl result from this in the relevant closure process of the locking mechanism compared to the state of the art.

This leads to further improved noise behavior, in particular during the closure process, compared to the class-specific state of the art according to WO 2014/082620 A2. In fact, the transition from the pre-ratchet position to the main ratchet position is especially “soft” and is practically not perceived acoustically. These are the fundamental advantages.

According to a further advantageous design the pawl initially interacts with the pre-ratchet and then the main ratchet in the inlet movement of the locking bolt which are provided on a common load arm of the catch. In addition to the relevant load arm defining the pre-ratchet and the main ratchet, the catch also possesses a collecting arm. The load arm and the collecting arm have an interposed infeed section for the locking bolt. The infeed section in the catch corresponds to the inlet opening in the latch case so that the locking bolt can engage unimpeded into the motor vehicle door latch in the closure process of the locking mechanism and can engage into the infeed section of the opened catch. The further inlet movement of the locking bolt now leads to the locking mechanism being closed as described.

The collecting arm of the catch is usually arranged preceding in the inlet direction of the locking bolt. In contrast, the load arm with the pre-ratchet recess and the main ratchet recess is a lagging arm. The collecting arm and the pawl are advantageously formed interaction-free. In the closure process of the locking mechanism, the pawl thus only executes the described pivoting movements taking into account the previously explained closure angle of less than 30°. Any impact on the movement of the pawl by the collecting arm therefore explicitly does not occur.

As previously explained, the locking bolt in the closure position of the locking mechanism defines the second lever compared to the catch axis vertically to the inlet direction of the locking bolt. The pre-ratchet or main ratchet of the catch specify the second lever arm in contrast which runs vertically to the inlet direction of the locking bolt compared to the catch axis and describes the distance of the pre-ratchet or the main ratchet from the axis. Both lever arms and consequently the blocking part ratio is settled in the range of at least 3:1 and in particular 4:1 or more according to the invention. Finally, the pawl and/or the catch may be equipped with an end stop which limits its pivoting movement in the closure process in relation to the catch. A comparable situation applies to the stop on the pawl.

As a result, a motor vehicle door latch is provided which is equipped with special advantages with regard to noise evolution. This can be primarily attributed to the arrangement of the locking bolt in front of the catch axis in the closure position of the locking mechanism. Furthermore, that the pawl describes a closure angle of less than 30° in the inlet movement of the locking bolt into the locking mechanism.

Furthermore, the construction is compact and has been implemented with a reduced number of components. This is primarily attributable to the distance of the locking bolt in front of the catch axis in the closure position of the locking mechanism provides construction space in the area of the inlet opening of the latch case which is used for the arrangement of the activation lever mechanism according to the invention. In fact, the activation lever mechanism can at least be largely accommodated on the latch case hereby, namely on its predominant L-leg, which is formed as a lever mechanism leg, predominantly for accommodation of the activation lever mechanism for this purpose.

This special characteristic of the predominant L-leg and its increase in area compared to the state of the art leads to any transitions to a latch lid sealing the latch case or a relevant latch housing being predominantly relocated inside one of the motor vehicle doors accommodating the motor vehicle door latch. Thus, the penetration of dust and/or water into the motor vehicle door latch is reduced compared to previous embodiments. These are the fundamental advantages.

The invention is explained in further detail hereafter on the basis of a drawing which only constitutes an exemplary embodiment. The following are shown:

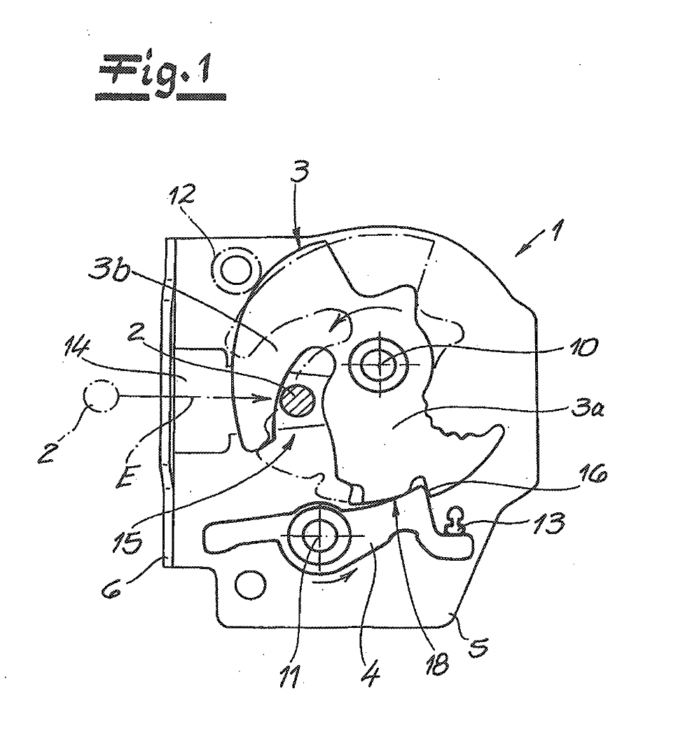

FIG. 1 the motor vehicle door latch in the pre-ratchet position according to the invention,

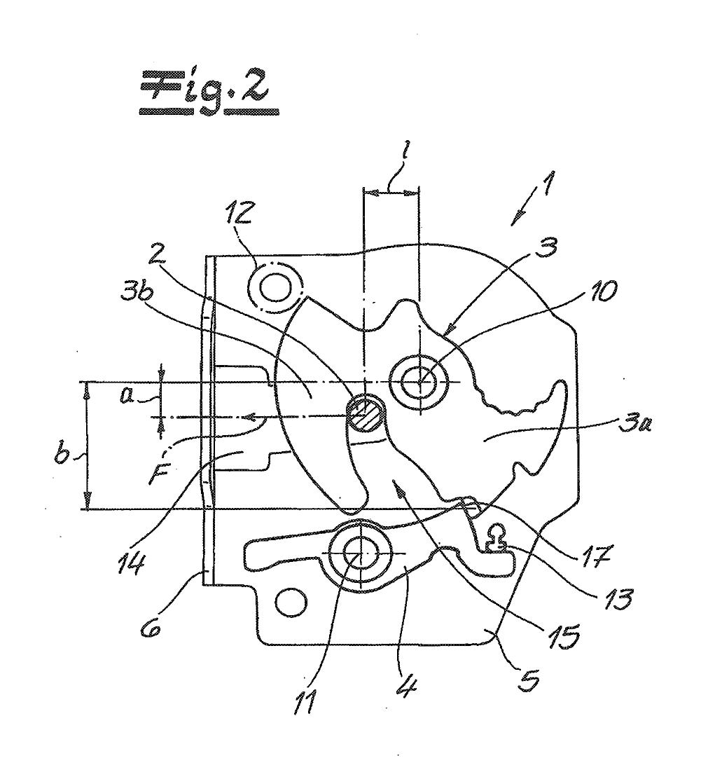

FIG. 2 the object according to FIG. 1 in the main ratchet position,

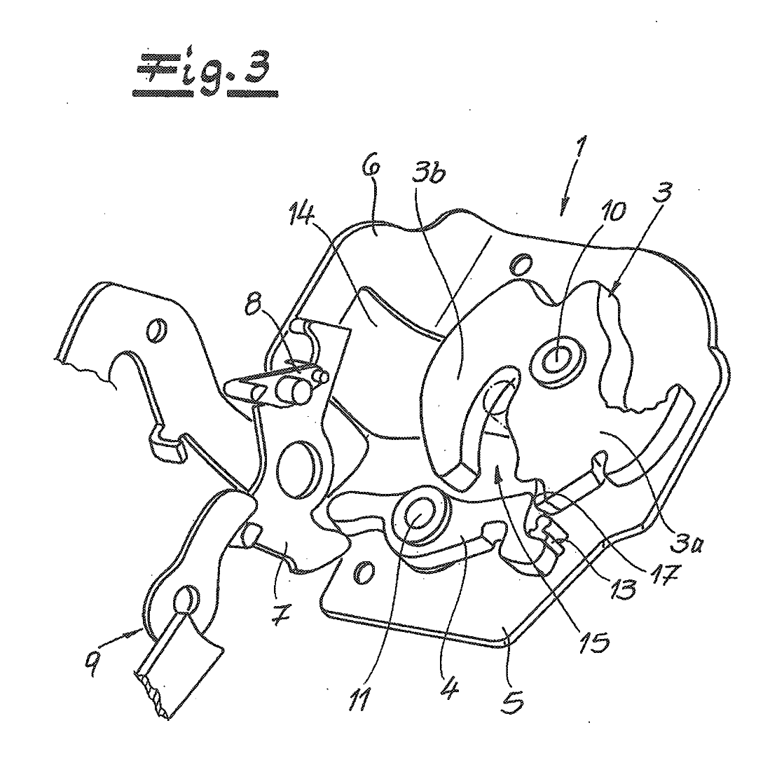

FIG. 3 a perspective view of the latch case with the inner workings in the motor vehicle door latch and

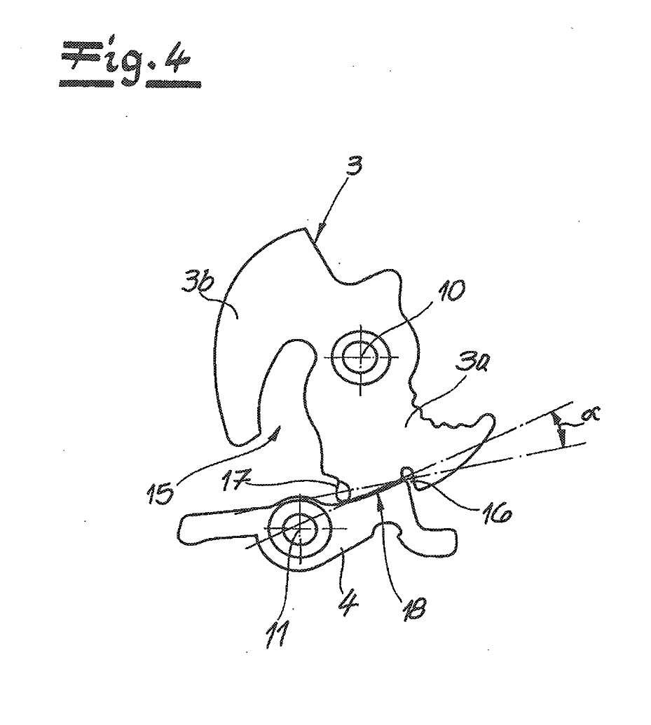

FIG. 4 a detail of the locking mechanism

A motor vehicle door latch is illustrated in the figures. In its basic construction, this comprises a motor vehicle door latch 1 and an interacting latch holder with a locking bolt 2. The motor vehicle door latch 1 is arranged in or on a motor vehicle door. The latch holder with the locking bolt 2 is located on the chassis side in contrast and may be connected to a B- or C-pillar on a non-illustrated motor vehicle chassis. Inside the motor vehicle door latch 1 a locking mechanism 3, 4 is arranged which fundamentally comprises a catch 3 and a pawl 4.

The locking mechanism 3, 4 is accommodated in a latch case 5, 6, more precisely in an L-leg 5 configured as a locking mechanism leg 5 of the L-shaped latch case 5, 6. In FIGS. 1 and 2 the locking mechanism leg 5 is illustrated in a horizontal top view. In contrast, the further L-leg 6 extends compared to this vertically and protrudes in the illustration according to FIGS. 1 and 2 from the drawing plane in the direction of the viewer. The L-leg 6 of the L-shaped latch case 5, 6 is formed as a lever mechanism leg 6 and serves for at least predominant accommodation of an activation lever mechanism 7, 8, 9, which is mainly recognized in the perspective illustration according to FIG. 3. For this purpose, the prominent L-leg 6 is connected to the horizontal L-leg 5 in the area of an inlet opening 14 for the locking bolt 2.

The catch 3 is pivotably accommodated around an axis 5 in the latch case 5, 6 or the locking mechanism leg 5. The same applies to the pawl 4, which is also pivotably accommodated around an axis 11 in the latch case 5, 6 or the locking mechanism leg 5. Furthermore, another indicated stop or rotational movement absorber 12 is apparent for the catch 3 and a stop 13 for the pawl 4.

Starting from the pre-ratchet position of the locking mechanism 3, 4 illustrated in FIG. 1, the closure process occurs by the locking bolt 2 being inserted into the locking mechanism 3, 4. In this process, the locking bolt 2 initially passes the inlet opening 14 in the latch case 5, 6 or in the locking mechanism leg 5. The locking bolt 2 then travels into an infeed section 15 of the catch 3. To this end, the catch 3 is located in its open position indicated in dot dashes in FIG. 1. The infeed section 15 of the catch 3 is defined both by a load arm 3a of the catch 3 and a collecting arm 3b of the catch 3. In fact, the load arm 3a and the collecting arm 3b describe the relevant infeed section 15 for the locking bolt 2 between themselves.

After the locking bolt 2 has entered the infeed section 15 of the open catch 3 illustrated in dot dashes in FIG. 1, a further inlet movement of the locking bolt 2 in the inlet direction E illustrated by an arrow in FIG. 1 leads to the locking mechanism 3, 4 being closed. For this purpose, the catch 3 executes a movement around its axis 10 in the anti-clockwise direction indicated in FIG. 1. After a specified amount of inlet movement by the locking bolt 2 the pawl 4 engages into a pre-ratchet recess 16 on the catch 3. For this purpose, the pawl 4 also executes an anti-clockwise movement around its axis 11. At the same time, the stop 13 prevents a movement of the pawl 4 beyond the position shown in FIG. 1.

After the locking mechanism 3, 4 has reached the pre-ratchet position illustrated in FIG. 1, a further inlet movement of the locking bolt 2 and a further anti-clockwise rotation of the catch 3 around its axis 10 finally leads to the locking mechanism 3, 4 attaining the main ratchet position shown in FIG. 2. The pawl 4 then engages into a main ratchet recess 17 of the catch 3. Once again, the stop 13 ensures limitation of the closure movement of the pawl 4.

If the closure position or main closure position of the locking mechanism 3, 4 is now viewed in FIG. 2, it is thus apparent that the locking bolt 2 is arranged at the end of its inlet movement into the locking mechanism 3, 4 in the inlet direction E and in the illustrated (main) closure position of the locking mechanism 3, 4, at a distance in front of the catch 3 axis 10. In fact, the distance of the locking bolt 2 in the (main) closure position of the locking mechanism 3, 4 in front of the relevant axis 10 of the catch 3 in the inlet direction E corresponds to the path I in FIG. 2.

By means of this configuration, a distance a of the locking bolt 2 to the stated axis 10 of the catch 3 is also observed vertically to inlet direction E or a force F to be described hereafter on the locking bolt 2. This distance a corresponds to a second lever or second lever arm a of a torque engaging on the axis 10 of the catch 3.

In addition to this second lever or second lever arm a, a first lever or first lever arm b is drawn in FIG. 2. This first lever or first lever arm b corresponds to the distance of the axis 10 of the catch 3 from the main ratchet recess 17 in the example case. The meaning of the lever arms a, b is as follows.

As soon as the locking mechanism 3, 4 assumes its (main) closure position according to the illustration in FIG. 2, any forces accumulated by a rubber door seal surrounding the motor vehicle door ensures that the locking bolt 2 is acted on with the force F in the FIG. 2 (to the left). The force F results from the non-illustrated rubber door seal and is configured as the force opening the locking mechanism 3, 4, i.e. directed contrary to the inlet direction E.

This force F engaging on the locking bolt 2 exerts a torque on the catch 3. This torque is measured from the product of the relevant force F multiplied by the second lever arm a arranged vertically. The resulting torque on the catch 3 is formed as an opening torque, therefore ensures—without the pawl 4—that the catch 3 is opened and releases the locking bolt 2. This is prevented with the aid of the pawl 4 which needs to apply a relevant countertorque on the main ratchet recess 17. This countertorque results from the product of the force F with the corresponding first lever arm b lying vertically to this.

The greater the ratio of the length of the first lever arm b compared to the length of the second lever arm a, i.e. b:a, the less the lever forces the pawl 4 needs to provide on the main ratchet recess 17. If the observed counterforces on the pawl 4 are slight, a pawl, even made of plastic, can thus be worked with.

The ratio of the lever arms b:a is also called blocking part ratio b:a. Within the scope of the configuration according to the invention blocking part ratios b:a of at least 3:1 and in particular 4:1 or more are observed. Thus, the counterforces to be accumulated by the pawl 4 are low in order to be able to hold the catch 3 in its (main) closure position according to FIG. 2. Consequently, the pawl 4 can be configured relatively easily and cost-effectively.

Furthermore, this configuration leads to the axis 10 of the catch 3 being able to be relocated compared to the locking bolt 2 in the (main) closure position according to FIG. 2 in the inlet direction E so to speak “behind” the locking bolt 2, according to path I. In the state of the art, configurations are observed in contrast in which path I does not exist or is zero or practically zero. However, the axis 10 of the catch 3 and consequently the catch 3 as a whole can be moved further “backwards” which, in the exemplary embodiment, leads to an increased distance of the relevant axis 10 compared to the vertically prominent L-leg 6 compared to the state of the art.

As a consequence hereof, the activation lever mechanism 7, 8, 9 according to FIG. 3 can be accommodated at least largely in the latch case 5, 6. In fact, in the illustration according to FIG. 3 it is apparent that a triggering lever 7 can be accommodated on the relevant L-leg 6 or the lever mechanism leg 6. The same applies to an internal activation lever 8. Only an external activation lever 9 is not accommodated on the relevant vertically prominent L-leg or the lever mechanism leg 6.

On the basis of FIG. 4 it becomes clear that the pawl 4 in the previously described inlet movement of the locking bolt 2 can execute different pivoting angles around its axis 11. These pivoting angles of the pawl 4 correspond to a maximum closure angle a illustrated in FIG. 4 which is primarily specified by the form of a ramp 18 between the pre-ratchet recess 16 and the main ratchet recess 17 on the catch 3. This is illustrated by the two legs of the closure angle a drawn in FIG. 4. In fact, one leg of the closure angle a primarily follows the contour of the ramp 18 (upper leg). In contrast, the other leg connects the main ratchet recess 17 to the highest point of the pawl 4, the location of which remains unchanged in the transition from the pre-ratchet position according to FIG. 1 to the main ratchet position according to FIG. 2 due to the stop 13 (lower leg in FIG. 4).

However, according to the invention, closure angles a are observed for the pawl 4, which are less than 30° and in particular less than 25°. In the exemplary embodiment, the closure angle a is even settled to the maximum at 20°. The closure angle a describes the pivoting angle around its axis 11 in the closure movement of the locking mechanism 3, 4 highlighted to the maximum by the pawl 4.

In the inlet movement of the locking bolt 2 into the locking mechanism 3, 4 the pawl 4 initially interacts with the pre-ratchet 16 and then with the main ratchet 17, as already described. The pre-ratchet 16 and the main ratchet 17 are jointly arranged on the load arm 3a of the catch 3. In addition to the load arm 3a the catch 3 also has the collecting arm 3b. As already explained at the start, the load arm 3a and the collecting arm 3b define the infeed section 15 between themselves.

The collecting arm 3b and the pawl 4 are formed interaction-free in the exemplary embodiment. i.e. in the transition from the open position of the catch 3 illustrated in dot dashes in FIG. 1 and therefore the locking mechanism 3, 4 to the main closure position or main ratchet position according to FIG. 2, a mechanical interaction of the collecting arm 3b with the pawl 4 does not occur. The pawl 4 is therefore not influenced in any way in its movement by the collecting arm 3b, but ensures the pivoting movement of the pawl, 4 solely the ramp 18, as already described.

The stop 12 on the catch 3 is not configured as an end stop in the present case, but as a movement damper so to speak. In fact, the stop 12 ensures that the catch 3 rolls off in its opening and closure movement and that its speed is consequently limited. A comparable speed limitation is also observed for the pawl 4. Because due to the slight closure angle a of less than 30°, the pawl 4 only executes low speeds around its axis 11 in the closure process of the locking mechanism 3, 4 and consequently also low accelerations. This leads to especially low-noise operation.

1. A motor vehicle door latch, with a motor vehicle door latch and an interacting latch holder with a locking bolt, furthermore with a locking mechanism arranged in the motor vehicle door latch fundamentally comprising a catch and a pawl, and with an activation lever mechanism working on the locking mechanism, whereby the catch is pivotably accommodated around an axis in and/or on a latch case, and whereby the locking bolt is arranged at the end of its inlet movement into the locking mechanism and in its closure position in an inlet direction (distance I) in front of the axis of the catch, wherein the activation lever mechanism is at least largely accommodated on the latch case.

2. The motor vehicle door latch according to claim 1, wherein the latch case is L-shaped in the cross-section, whereby an L-leg is formed as a locking mechanism leg for accommodation of the locking mechanism and the other L-leg as a lever mechanism leg for accommodation of at least a large part of the activation lever mechanism.

3. The motor vehicle door latch according to claim 1, wherein the pawl describes a closure angle of less than 30°, in particular less than 25° and preferably of 20° and less in the inlet movement of the locking bolt into the locking mechanism, namely in relation to its axis.

4. The motor vehicle door latch according to claim 1, wherein the pawl initially interacts with a pre-ratchet recess and then with a main ratchet recess on a joint load arm of the catch in the inlet movement of the locking bolt into the locking mechanism.

5. The motor vehicle door latch according to claim 4, wherein the catch in addition to the load arm is also equipped with a collecting arm, whereby the load arm and the collecting arm define an infeed section for the locking bolt between themselves.

6. The motor vehicle door latch according to claim 5, wherein the collecting arm and the pawl are formed in an interaction-free manner.

7. The motor vehicle door latch according to claim 1, wherein the pre-ratchet recess or the main ratchet recess of the catch describe a first lever arm compared to the axis of the catch vertically to the inlet direction of the locking bolt.

8. The motor vehicle door latch according to claim 1, wherein the locking bolt in the closure position of the locking mechanism defines a second lever arm (a) compared to the axis of the catch vertically to its inlet direction.

9. The motor vehicle door latch according to claim 7, wherein the two lever arms have a ratio of at least b:a equal to 3:1 and in particular 4:1 or more.

10. The motor vehicle door latch according to claim 1, wherein the catch and/or the pawl have an end stop.
